(19) United States
(12) Patent Application Publication
(10) Pub. No.: US 2021/0117558 A1
(43) Pub. Date: Apr. 22, 2021

(54) GRANTING APPLICATION PRIVILEGES

(71) Applicant: LENOVO (Singapore) PTE. LTD., New Tech Park (SG)

(72) Inventors: Timothy Robbins, Avon, IN (US); Matthew Fardig, Boonville, IN (US); Lindsay Nelson, Highlands Ranch, CO (US); Christopher Romano, CIncinnati, OH (US)

(21) Appl. No.: 16/659,922

(22) Filed: Oct. 22, 2019

(51) Int. Cl. G06F 21/60

(52) U.S. Cl. CPC G06F 21/604

(57) ABSTRACT

For granting administrator privileges, a processor detects satisfaction of an intervention criteria for an application that is in cooperative use by a plurality of users. None of the plurality of users is empowered with administrator privileges. In response to satisfying the intervention criteria, the processor grants the administrator privileges to a designated user of the plurality of users.

### FIELD

The subject matter disclosed herein relates to granting application privileges.

### BACKGROUND

Non-privileged users may need administrator privileges.

### BRIEF SUMMARY

An apparatus for granting administrator privileges is disclosed. The apparatus includes a processor and a memory that stores code executable by the processor. The processor detects satisfaction of an intervention criteria for an application that is in cooperative use by a plurality of users. None of the plurality of users is empowered with administrator privileges. In response to satisfying the intervention criteria, the processor grants the administrator privileges to a designated user of the plurality of users. A method and program product also perform the functions of the apparatus.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of an application;

FIG. 2 is a schematic block diagram illustrating one embodiment of application data;

FIG. 3A is a drawing illustrating one embodiment of a user interface;

FIG. 3B is a drawing illustrating one alternate embodiment of a user interface;

FIG. 4 is a schematic block diagram illustrating one embodiment of a computer; and

FIG. 5 is a schematic flow chart diagram illustrating one embodiment of an application privilege grant method.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise. The term “and/or” indicates embodiments of one or more of the listed elements, with “A and/or B” indicating embodiments of element A alone, element B alone, or elements A and B taken together.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

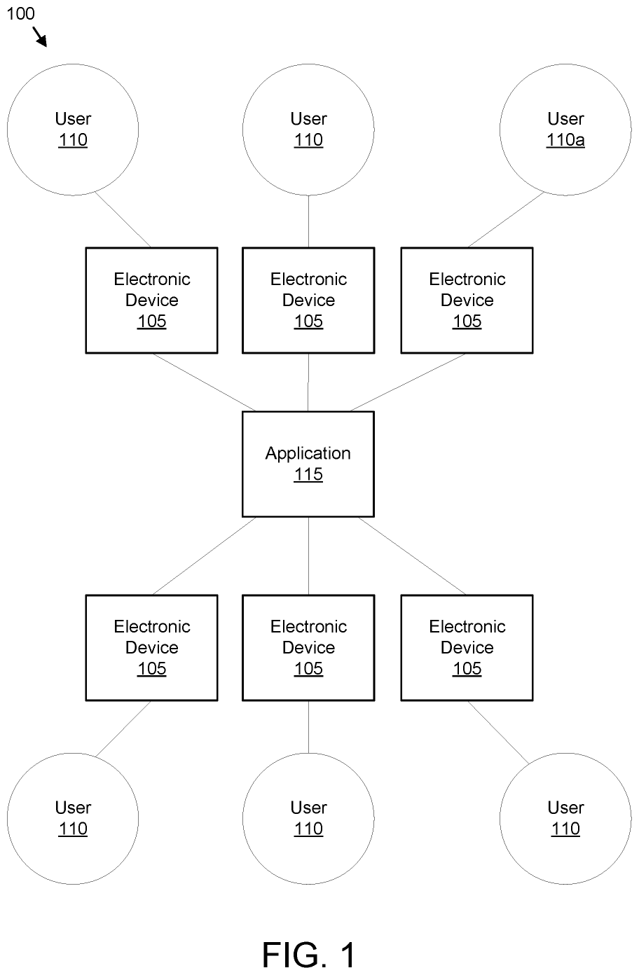

FIG. 1 is a schematic block diagram illustrating one embodiment of an application system 100. The application system 100 includes an application 115. The application 115 may be selected from the group consisting of conferencing services and document sharing. The application 115 may be in cooperative use by a plurality of users 110. None of the plurality of users 110 may be empowered with administrator privileges. In addition, none of the plurality of users 110 may be initially empowered with the administrator privileges. In one embodiment, the application 115 communicates with each user 110 through an electronic device 105. In addition, the application 115 may communicate directly with one or more users 110.

The users 110 may interact with the application 115. The users 110 may also interact with each other through the application 115. At times during the interaction, a user 110 and/or electronic device 105 may disrupt the cooperative use of the application 115. For example, the user 110 may leave the vicinity of his electronic device 105 with the microphone unmuted, and the microphone may begin picking up distracting noises that interfere with the cooperative use of the application 115.

Unfortunately, because none of the users 110 are empowered with administrator privileges, no user 110 is able to remedy the disruption. The embodiments described herein detect satisfaction of an intervention criteria and grant administrator privileges to a designated user 110a so that the designated user 110a may remedy the disruption as will be described hereafter.

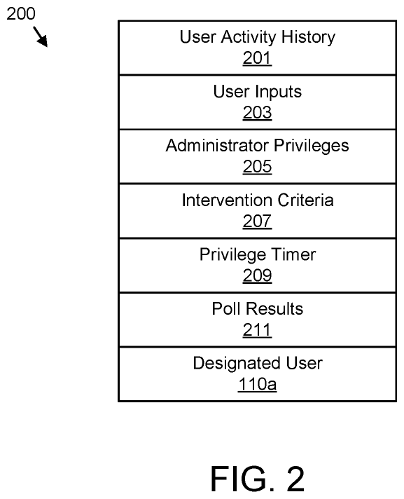

FIG. 2 is a schematic block diagram illustrating one embodiment of application data 200. The application data 200 maybe organized as a data structure in a memory. In the depicted embodiment, the application data 200 includes a user activity history 201, user inputs 203, the administrator privileges 205, the intervention criteria 207, a privilege timer 209, poll results 211, and the designated user 110a.

The user activity history 201 may record a user's interaction with the application 115. For example, the user activity history 201 may record each time a user 110 makes a vocal, text, drawing, editing, and/or upload contribution to the application 115. In one embodiment, each contribution is time stamped.

The user inputs 203 may include the audio, video, text, drawings, and/or files received from each user 110. In one embodiment, the user inputs 203 are buffered for a specified time interval.

The administrator privileges 205 may allow the designated user 110a to restrict the user input 203 from one or more users 110. In addition, the administrator privileges 205 may allow the designated user 110a to remove previous user input 203 from a user 110. In one embodiment, the administrator privileges 205 allow the designated user 110a to remove the user 110 from communicating with and/or interacting with the application 115. In a certain embodiment, the administrator privileges 205 include privilege metadata that specify privileges for each user 110 including the designated user 110a.

The intervention criteria 207 specifies one or more circumstances requiring the intervention of the designated user 110a using the administrator privileges 205. The intervention criteria 207 may specify an audio disturbance. The audio disturbance may be an audio user input 203 that exceeds an audio threshold. In one embodiment, the audio threshold is 65 decibels (dB). In addition, the audio disturbance may be one or more phrases that violate a civility threshold. For example, the audio threshold may comprise a list of phrases that are considered profane and/or inappropriate. The intervention criteria 207 may be satisfied when the audio disturbance is detected.

The intervention criteria 207 may further specify a video disturbance. The video disturbance may specify images that are considered obscene and/or inappropriate. In addition, the video disturbance may specify a video change rate that detects rapid movements that are distracting. The intervention criteria 207 may be satisfied when the video disturbance is detected.

The intervention criteria 207 may specify a text disturbance. The text disturbance may specify words that are considered profane, obscene, and/or inappropriate. The intervention criteria 207 may be satisfied when the text disturbance is detected.

The intervention criteria 207 may further specify a document disturbance. The document disturbance may specify text, images, and the like that are considered obscene, profane, and/or inappropriate. The intervention criteria 207 may be satisfied when the document disturbance is detected.

The privilege timer 209 may count down a maximum time interval. The maximum time interval may specify the longest time that the designated user 110a is granted the administrator privileges 205. The maximum time interval may be in the range of 3 to 15 minutes.

The poll results 211 may record polling inputs from each of the users 110. The designated user 110a may record which user 110 is the designated user 110a.

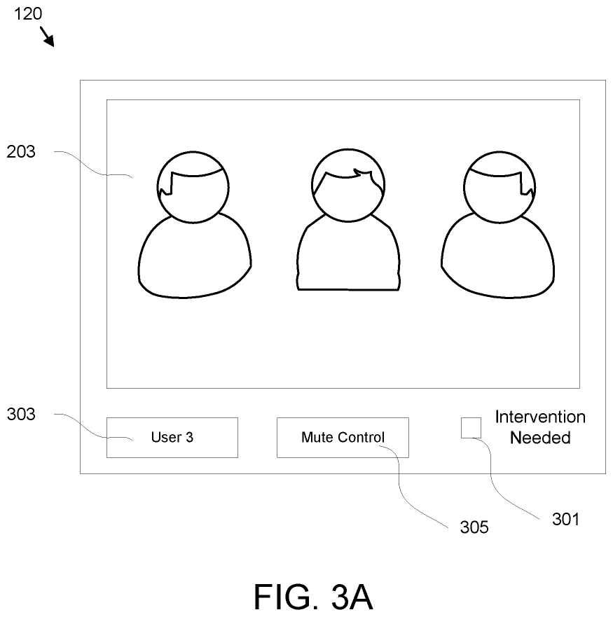

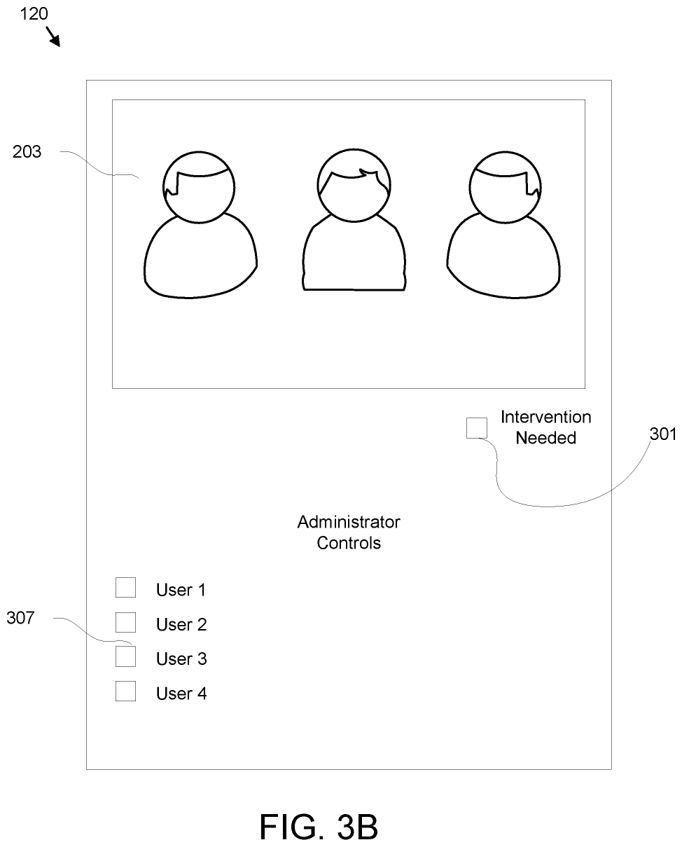

FIG. 3A is a drawing illustrating one embodiment of a user interface 120 for the application 115. In the depicted embodiment, the application 115 provides conferencing services. User inputs 203 in the form of video images from the users 110 are presented through the user interface 120.

In one embodiment, the user interface 120 includes a poll 301 that may be selected to indicate that an intervention is needed. The poll 301 may further be unselected to indicate that the intervention is no longer needed. The user interface 120 further includes a designated user selection 303. A user 110 may indicate a preference for a user 110 to be the designated user 110a with the designated user selection 303. For example, the user 110 may indicate a preference for user 3 to become the designated user 110a as is shown. Selecting the poll 301 may result in the user interface 120 querying for the designated user selection 303.

The user interface 120 may further include an administrator privileges selection 305. The user 110 may indicate a preference for the administrator privileges 205 that are granted to the designated user 110a with the administrator privileges selection 305. Selecting the poll 301 may result in the user interface 120 querying for the administrator privileges selection 305.

FIG. 3B is a drawing illustrating one alternate embodiment of a user interface 120 for the designated user 110a with administrator controls 307 corresponding to the granted administrator privileges 205. In the depicted embodiment, a designated user 110a has been selected and granted the administrator privileges 205. As a result, administrator controls 307 are presented to the designated user 110a. In the depicted embodiment, the designated user 110a may select a user 110 to mute. For example, selecting any user 110 may mute the audio user input 203 for the selected user 110.

In one embodiment, the user may deselect the poll 301 to indicate that intervention is no longer needed.

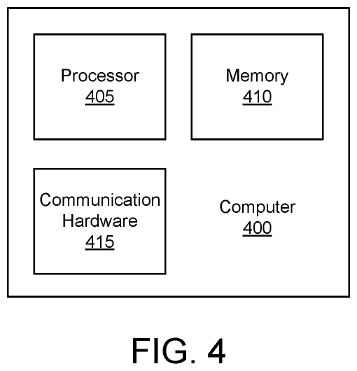

FIG. 4 is a schematic block diagram illustrating one embodiment of a computer 400. The computer 400 may execute the application 115. In addition, each electronic device 105 may include a computer 400. In the depicted embodiment, the computer 400 includes a processor 405, a memory 410, and communication hardware 415. The memory 410 may include a semiconductor storage device, hard disk drive, an optical storage device, or combinations thereof. The memory 410 may store code. The processor 405 may execute the code. The communication hardware 415 may communicate with other devices.

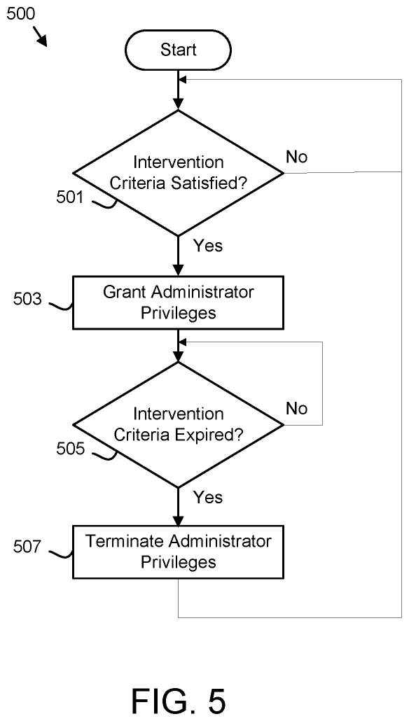

FIG. 5 is a schematic flow chart diagram illustrating one embodiment of an application privilege grant method 500. The method 500 may detect satisfaction of the intervention criteria 207 and grant administrator privileges 205 to the designated user 110a. The method 500 may be performed by the computer 400 and/or processor 405.

The method 500 starts, and in one embodiment, the processor 405 detects 501 satisfaction of the intervention criteria 207 in the application 115. The application 115 may be an cooperative use by the plurality of users 110. In addition, none of the plurality of users 110 is initially empowered with the administrator privileges 205.

In one embodiment, the intervention criteria 207 is satisfied in response to a disturbance on the user inputs 203. The processor 405 may detect 501 the audio disturbance, the video disturbance, the text disturbance, and/or the document disturbance. Thus the processor 405 may automatically detect 501 the satisfaction of the intervention criteria 207 without any action by the users 110.

In one embodiment, the intervention criteria 207 is satisfied in response to the poll 301 of the plurality of users 110 indicating that an intervention is needed. The intervention criteria 207 may be satisfied if a minimum threshold of users 110 indicate through the poll 301 that the intervention is needed. The minimum threshold may be in the range of 2 to 5. In addition, the intervention criteria 207 may be satisfied if a majority of the users 110 indicate via the poll 301 that the intervention is needed.

If the intervention criteria 207 is not satisfied, the processor 405 continues to detect 501 whether the intervention criteria 207 is satisfied. If the intervention criteria 207 is satisfied, the processor 405 grants 503 the administrator privileges 205 to a designated user 110a of the plurality of users 110.

In one embodiment, the designated user 110a is selected based on the user activity history 201. The user 110 that has made the most contributions as indicated by the user activity history 201 may be selected as the designated user 110a. In addition, the user 110 that is made the most recent contributions within a recent contribution time interval may be selected as the designated user 110a.

In one embodiment, the poll 301 queries to select the designated user 110a. A user 100 that is selected by the most other users 110 via the designated user selection 303 may be selected as the designated user 110a. In addition, the poll 301 may query to select the administrator privileges 205 for the designated user 110a. In a certain embodiment, the administrator privileges 205 that are selected by a majority of users 110 via the administrator privileges selection 305 may be granted to the designated user 110a.

The processor 405 may detect 505 whether the intervention criteria 207 is expired. In one embodiment, the intervention criteria 207 expires when the privilege timer 209 expires. For example, if the privilege timer 209 counts down a 10 minute maximum time interval, the intervention criteria 207 may expire after the 10 minute privilege timer 209 counts down to zero.

In one embodiment, the expiration of the intervention criteria 207 is detected 505 in response to the disturbance terminating. For example, if the intervention criteria 207 was initially satisfied in response to a disturbance on a first user input 203, the expiration of the intervention criteria 207 may be detected 505 when that disturbance on the first user input 203 terminates.

In one embodiment, the processor 405 detects 505 the expiration of the intervention criteria 207 in response to the poll 301 indicating that intervention is no longer needed. For example, if the majority of the users 110 deselect the poll 301, the processor 405 may detect 505 the expiration of the intervention criteria 207.

If the expiration of the intervention criteria 207 is not detected 505, the processor 405 continues to detect 505 whether the intervention criteria 207 is expired. If the expiration of the intervention criteria 207 is detected 505, the processor 405 terminates 507 the administrator privileges 205 for the designated user 110a and the processor 405 continues to detect 501 satisfaction of the intervention criteria 207.

By detecting the satisfaction of the intervention criteria 207 and granting the administrator privileges 205 to the designated user 110a, the embodiments allow the designated user 110a to resolve disturbances and other issues that may arise during cooperative use of the application 115 by the users 110, even when none of the plurality of users 110 is empowered with the administrator privileges 205. As a result, the disturbances and/or other issues may be dealt with in a timely manner, enhancing the utility of the application 115 and/or the computer 400 hosting the application 115.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a processor;
a memory that stores code executable by the processor to:
detect satisfaction of an intervention criteria for an application that is in cooperative use by a plurality of users, wherein none of the plurality of users is empowered with administrator privileges; and
in response to satisfying the intervention criteria, grant the administrator privileges to a designated user of the plurality of users.

2. The apparatus of claim 1, wherein the intervention criteria is satisfied in response to a disturbance on user inputs.

3. The apparatus of claim 2, wherein the code is further executable by the processor to:
in response to the disturbance terminating, detect expiration of the intervention criteria; and
terminate the administrator privileges for the designated user.

4. The apparatus of claim 2, wherein the designated user is selected based on user activity history.

5. The apparatus of claim 1, wherein the intervention criteria is satisfied in response to a poll of the plurality of users indicating an intervention is needed.

6. The apparatus of claim 5, wherein the code is further executable by the processor to:
in response to the poll indicating intervention is no longer needed, detect expiration of the intervention criteria; and
terminate the administrator privileges for the designated user.

7. The apparatus of claim 5, wherein the poll queries to select the designated user.

8. The apparatus of claim 5, wherein the poll queries to select the administrator privileges for the designated user.

9. The apparatus of claim 1, wherein the application is selected from the group consisting of conferencing services and document sharing.

10. A method comprising:
detecting, by use of a processor, satisfaction of an intervention criteria for an application that is in cooperative use by a plurality of users, wherein none of the plurality of users is empowered with administrator privileges; and
in response to satisfying the intervention criteria, granting the administrator privileges to a designated user of the plurality of users.

11. The method of claim 10, wherein the intervention criteria is satisfied in response to a disturbance on user inputs.

12. The method of claim 11, the method further comprising:
in response to the disturbance terminating, detecting expiration of the intervention criteria; and
terminating the administrator privileges for the designated user.

13. The method of claim 12, the designated user is selected based on user activity history.

14. The method of claim 10, wherein the intervention criteria is satisfied in response to a poll of the plurality of users indicating an intervention is needed.

15. The method of claim 14, the method further comprising:
in response to the poll indicating intervention is no longer needed, detecting expiration of the intervention criteria; and
terminating the administrator privileges for the designated user.

16. The method of claim 14, wherein the poll queries to select the designated user.

17. The method of claim 14, wherein the poll queries to select the administrator privileges for the designated user.

18. The method of claim 10, wherein the application is selected from the group consisting of conferencing services and document sharing.

19. A program product comprising a computer readable storage medium that stores code executable by a processor, the executable code comprising code to:
detect satisfaction of an intervention criteria for an application that is in cooperative use by a plurality of users, wherein none of the plurality of users is empowered with administrator privileges; and
in response to satisfying the intervention criteria, grant the administrator privileges to a designated user of the plurality of users.

20. The program product of claim 19, wherein the intervention criteria is satisfied in response to a disturbance on user inputs.
